(19) United States
(12) Patent Application Publication
(10) Pub. No.: US 2004/0135909 A1
(43) Pub. Date: Jul. 15, 2004

(54) Image signal processing system

(76) Inventor: Duck Young Jung, Yongin-city (KR)

Correspondence Address: CANTOR COLBURN LLP, 55 Griffin Road South, Bloomfield, CT, 06002, US

(21) Appl. No.: 10/744,887

(22) Filed: Dec. 23, 2003

(30) Foreign Application Priority Data
Dec. 23, 2002 (KR) 2002-82889

(51) Int. Cl. H04N 5/335

(52) U.S. Cl. 348/296

(57) ABSTRACT

An image signal processing system comprises an image sensor for receiving images of a subject in a form of light under the control of a shutter control signal and generating analog signals, an A/D converter for varying a comparison voltage range according to the shutter control signal and converting the analog signals of the image sensor into digital signals according to the varied comparison voltage range, and an image data processor for receiving output signals of the A/D converter to obtain movement values and generating the shutter control signal controlling an exposure time of the image sensor. The image signal processing system can realize high definition using the low resolution A/D converter, and occupies a small area in the semiconductor integrated circuit, and has low power consumption. Further, the image signal processing system can make use of the A/D converter in which a signal-to-noise is ratio of the input signal is relatively low.

### CROSS-REFERENCE TO RELATED APPLICATION

This application claims the benefit of Korean Patent Application No. 2002-82889, filed on Dec. 23, 2002, the disclosure of which is hereby incorporated herein by reference in its entirety.

### BACKGROUND OF THE INVENTION

1. Field of the Invention

The present invention relates to an image signal processing system and, more particularly, to an image signal processing system designed to realize high definition using an A/D converter having low resolution.

2. Description of the Related Art

FIG. 1 shows an internal block diagram of a conventional image signal processing system.

Referring to FIG. 1, the conventional image signal processing system includes an image sensor 110, an A/D converter 120, an image data processor 130 and a shutter controller 140.

The image sensor 110 is provided with a plurality of pixels, each of which responds to a shutter control signal CSHT to generate a voltage proportional to a quantity of light inputted when a shutter is turned on. Then, when the shutter is turned off, the image sensor 110 outputs a plurality of analog signals IM0, each of which has the generated voltage of each pixel.

The A/D converter 120 receives each analog signal IM0 of the image sensor 110, and converts the received analog signals into a plurality of N-bit digital signals ADC0.

The image data processor 130 receives the plurality of N-bit digital signals ADC0 which are outputted from the A/D converter 120, calculates movement values using the received N-bit digital signals ADC0, and outputs the calculated movement values.

Further, the image data processor 130 determines exposure times of the image sensor 110 which allow the quantity of light inputted into the image sensor 110 to be maintained within a predetermined range using the received N-bit digital signals ADC0, generates first shutter control signals CSHT1 having m-bit code values corresponding to the determined exposure times, and provides the generated result to the shutter controller 140.

The shutter controller 140 receives the first shutter control signals CSHT1 which are provided from the image data processor 130, generates second shutter control signals CSHT2 having a pulse width corresponding to the first shutter control signals CSHT1, and provides the generated second shutter control signals CSHT2 to an electronic shutter (not shown) composed of a CMOS (Complementary Metal Oxide Semiconductor) transistor within the image sensor 110.

In the above-mentioned configuration, the description has been made about that the image data processor 130 is functionally separated from the shutter controller 140, but the image data processor 130 may include the function of the shutter controller 140, if necessary.

FIG. 2 is a graph explaining a method for determining exposure times of the image sensor of the image data processor of FIG. 1.

In FIG. 2, plotted lines represents the generated voltages PS1 to PS3 of each unit pixel of the image sensor 110, an X axis represents an exposure time of the image sensor 110, and a Y axis represents a code corresponding to the generated voltage.

Here, the image signal processing system includes the 4-bit A/D converter 120 having a code value range of “0˜15” and a central code value of “7,” and the image sensor 110 having three pixels.

Under this assumption, referring to FIG. 2 now, the image data processor 130 selects an exposure time TS so that an average value of three charged voltages PS1 to PS3 outputted from the image sensor 110 is distributed at “7” as the central code value of the A/D converter 120.

In other words, the image data processor 130 selects the exposure time TS so that an average voltage between the charged voltage PS1 having the minimum voltage value and the charged voltage PS3 having the maximum voltage value on the basis of the same time is distributed on “7” of the central code value of the A/D converter 120.

Further, the image data processor 130 generates the first shutter control signals CSHT1 having a code value corresponding to the selected exposure time TS.

Actually, the image sensor 110 may have pixels ranging from one to several millions, and all pixels are controlled by the shutter control signals CSHT2 having the same value.

Thus, in the case where light inputted onto the image sensor 110 becomes excessively much or little, the average values of the analog signals IM0 provided from the image sensor 110 are excessively placed on the side of the upper limit codes CODE10 to CODE15 or the lower limit codes CODE0 to CODE5 of the A/D converter 120.

In this case, the A/D converter fails to normally recognize these signals, thus failing to perform normal analog-to-digital conversion. In other words, the A/D converter does not generate the digital signals which the image signal processing system requires.

Thus, the conventional image signal processing system is provided with image data processor 130 controlling the exposure time of the image sensor 110, thereby allowing the analog signals IM0 generated through the image sensor 110 to be always distributed on the central code of the A/D converter 120.

FIG. 3 shows one embodiment of a circuit diagram of the A/D converter of FIG. 1, in which the A/D converter 120 includes a comparison voltage generator 310 and an N-bit comparator 320.

The comparison voltage generator 310 receives fixed reference voltage values from first and second reference voltages Vref1 and Vref2, and determines a comparison voltage range, which is divided into N numbers. The N comparison voltages, each of which becomes a reference of each of the N codes provided from the A/D converter 120, are generated and outputted. Hence, voltage differences between comparison voltages generated from the comparison voltage generator 310 are uniformly maintained at all times.

The N-bit comparator 320 compares the N comparison voltages transmitted from the comparison voltage generator 310 with the voltages of the analog signals IM0 transmitted from the image sensor 110, and outputs the compared resultant values in an N-bit digital signal form.

In this manner, the conventional A/D converter converts the analog signals into the N-bit digital signals using the N comparison voltages having the uniform voltage difference at all times.

Thus, in the case where the voltage differences of the analog signals inputted into the A/D converter are large enough to be distinguishable by the N comparison voltages, the A/D converter recognizes the voltage differences of the analog signals IM0 and generates the N-bit digital signals corresponding to each voltage.

Thus, the conventional A/D converter is able to provide the image reflecting the shape of the subject exactly to the image data processor.

By contrast, in the case where the voltage differences of the analog signals IM0 inputted into the A/D converter are small enough to be indistinguishable by the N comparison voltages, the A/D converter fails to distinguish the voltage differences of the analog signals IM0, so that the A/D converter can not provide the image reflecting the shape of the subject exactly to the image data processor.

Generally, the image signal processing system has an objective of recognizing the image of the subject with accuracy. Thus, conventionally, this objective is accomplished by the high resolution A/D converter capable of distinguishing even very small voltage differences.

However, with the high resolution A/D converter, there is a problem in that both the layout and the consumption power of the image signal processing system are inevitably increased.

For instance, if the circuit of the A/D converter by nature has the number of bits increased by 1, the chip size of the A/D converter increases twice, and thus the consumption power of the A/D converter increases twice.

### SUMMARY OF THE INVENTION

It is, therefore, an object of the present invention to provide an image signal processing system capable of realizing high definition using an A/D converter having low resolution.

In order to accomplish this object, according to one aspect of the present invention, there is provided an image signal processing system comprising: an image sensor for receiving images of a subject in a form of light under the control of a shutter control signal and generating analog signals; an A/D converter for varying a comparison voltage range according to the shutter control signal and converting the analog signals of the image sensor into digital signals according to the varied comparison voltage range; and an image data processor for receiving output signals of the A/D converter to obtain movement values and generating the shutter control signal controlling an exposure time of the image sensor.

Preferably, the shutter control signal has a predetermined bit of code value.

Further, the A/D converter comprises: a control signal generator for generating a voltage value of the shutter control signal; a variable comparison voltage generator for varying the comparison voltage range according to the voltage value and generating and outputting a plurality of comparison voltages corresponding to the varied comparison voltage range; and a comparator for converting the analog signals into the digital signals using the plurality of comparison voltages of the variable comparison voltage generator.

A first type of the variable comparison voltage generator comprises: a comparison voltage range adjustor for continuously varying the comparison voltage range according to the shutter control signal; and a comparison voltage 10 generator for generating and outputting the plurality of comparison voltages corresponding to the varied comparison voltage range.

Preferably, the comparison voltage range adjustor is a variable resistor.

A second type of the variable comparison voltage generator comprises: a comparison voltage range adjustor for setting a range of the plurality of comparison voltages and selecting a particular range of the plurality of comparison voltages according to the shutter control signal; and a comparison voltage generator for generating and outputting the plurality of comparison voltages corresponding the selected range of the plurality of comparison voltages.

Preferably, the comparison voltage range adjustor comprises: a predetermined number of switches connected to a power supply on one side thereof and controlled in response to the shutter control signal; and a predetermined number of resistors connected between the other side of the switches and the comparison voltage generator.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 shows a block circuit diagram of a conventional image signal processing system;

FIG. 2 is a graph explaining a method for determining exposure times of the image sensor of the image data processor of FIG. 1;

FIG. 3 shows one embodiment of the block circuit diagram of the AID converter of FIG. 1;

FIG. 4 is an internal block diagram of an A/D converter according to the invention;

FIG. 5 is a circuit diagram of an A/D converter according to one embodiment of the invention; and

FIG. 6 is a circuit diagram of an A/D converter according to another embodiment of the invention

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. Like numbers refer to like elements throughout the specification.

FIG. 4 is an internal block diagram of an A/D converter according to the invention.

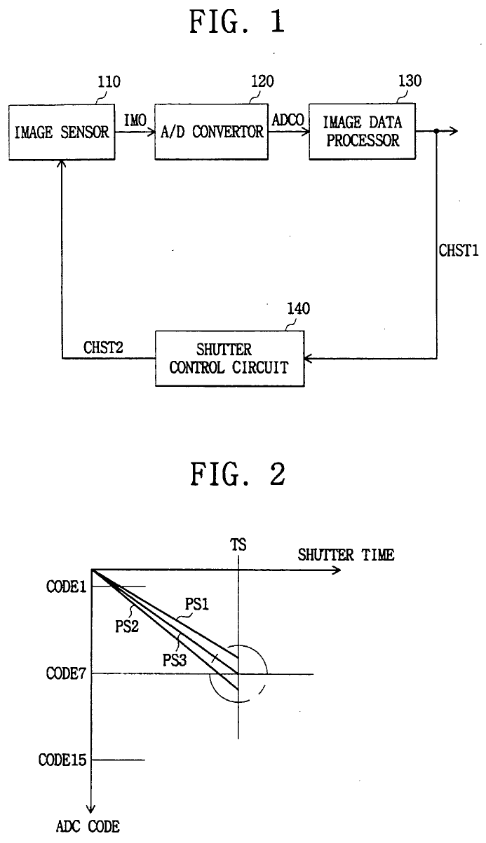

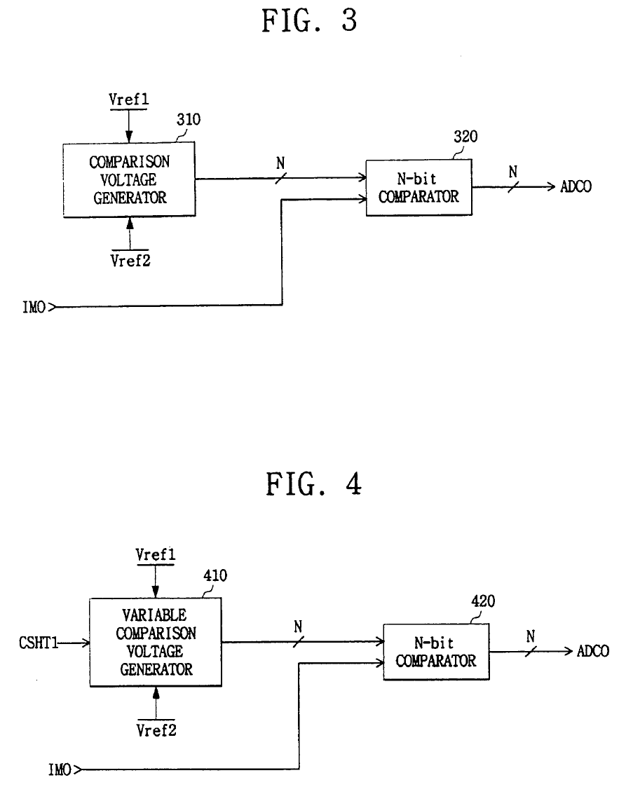

As shown in the drawing, the A/D converter of the invention includes a variable comparison voltage generator 410 and an N-bit comparator 420, and makes the first shutter control signals CHST1 of the image data processor 130 of FIG. 1.

The variable comparison voltage generator 410 receives fixed reference voltage values from first and second reference voltages Vref1 and Vref2, and varies a range of comparison voltages provided to the N-bit comparators 420 in response to the first shutter control signal CHST1.

Then, the varied range of the comparison voltages is divided into N numbers. The N comparison voltages are generated and outputted.

Thus, voltage differences between the comparison voltages generated from the variable comparison voltage generator 410 are variously adjusted according to the first shutter control signals CHST1.

With the variable comparison voltage generator 410, a plurality of subdivided comparators or analog continuous voltage control can be applied.

The N-bit comparator 420 receives the N comparison voltages provided from the variable comparison voltage generator 410 and the analog signals IM0 provided from the image sensor 110 to compare voltage magnitudes, and generates and outputs N-bit digital signals ADC0 corresponding to the compared results.

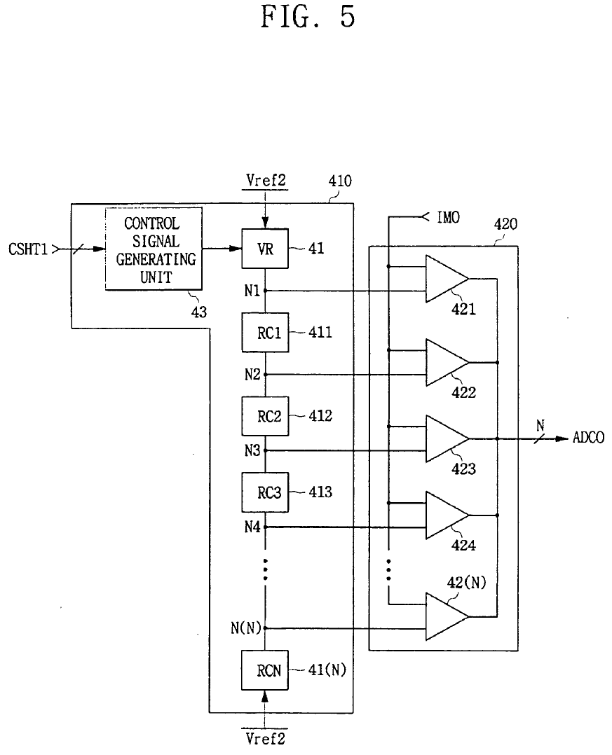

FIG. 5 is a circuit diagram of an A/D converter according to one embodiment of the invention.

Referring to FIG. 5, the variable comparison voltage generator 410 includes a variable resistance circuit 41 connected with the first reference voltage Vref1 and varying resistance values VR in response to comparison voltage control signals, N variable comparison voltage generating circuits 411 to 41N which are dependently connected in series between the variable resistance circuit 41 and the second reference voltage Vref2, and a control signal generating unit 43 generating the comparison voltage control signals having voltage values adjusted in response to the-first shutter control signals CHST1.

The N-bit comparator 420 is composed of N comparators 421 to 42N, which are connected with the variable comparison voltage generating circuits 411 to 41N, respectively.

Each of the first shutter control signals CHST1 is a digital signal, a code value of which is changed according to an exposure time. Thus, the control signal generating unit 43 generates voltage values of the comparison voltage control signals to which the code values of the first shutter control signals CHST1 correspond. The variable resistance circuit 41 varies its resistance values VR according to the voltage values of the comparison voltage control signals.

Hereinafter, an operation of the A/D converter of the invention will be described with reference to FIG. 5.

Here, it is assumed that all the N variable comparison voltage generating circuits 411 to 41N of the A/D converter have the same resistance value R.

The control signal generating unit 43 adjusts the voltage values of the comparison voltage control signals according to a pulse width of the first shutter control signals CHST1, and the variable resistance circuit 41 varies the resistance values VR in response to the comparison voltage control signals having the adjusted voltage values.

The variable resistance circuit 41 having the varied resistance values VR outputs a comparison voltage having a value of “Vref1−(Vref1−Vref2)×VR/(VR+N×R)” to a first output node N1.

Then, the first comparison voltage generating circuit 411 outputs the comparison voltage having a value of “Vref1−(Vref1−Vref2)×(VR+R)/(VR+N×R)” to a second output node N2, and the second comparison voltage generating circuit 411 outputs a comparison voltage having a value of “Vref1−(Vref1−Vref2)×(VR+2R)/(VR+N×R)” to a third output node N3.

In this manner, the third to N^{th} comparison voltage generating circuits 413 to 41N output the corresponding comparison voltages to fourth to N^{th} output nodes N4 to NN. The N comparators 421 to 42N receiving the corresponding comparison voltages compare magnitudes of the comparison voltages with those of the voltages of the analog signals IM0 outputted from the image sensor, and output the compared results.

The N-bit comparator 420 generates and outputs N-bit digital signals ADC0 corresponding to values of the N compared results of the N comparators 421 to 42N.

In this manner, the A/D converter of FIG. 5 outputs the N-bit digital signals as in the conventional A/D converter and continuously varies the range of comparison voltages according to the first shutter control signals CHST1, thus increasing its resolution.

In the above-mentioned configuration, the variable resistance circuit 41 is disposed between the first reference voltage Vref1 and the second reference voltage generating circuit 411 and the voltage differences of adjacent comparison voltages provided by the A/D converter are varied. However, if 10 necessary, the variable resistance circuit 41 is disposed between the second reference voltage Vref2 and the N^{th} comparison voltage generating circuit 41N and the voltage differences of adjacent comparison voltages provided by the A/D converter may be also varied.

Further, in the same method as that, the first variable resistance circuit may be disposed both between the first reference voltage Vref1 and the first comparison voltage generating unit 411 and the second variable resistance circuit may be disposed between the second reference voltage Vref2 and the N^{th} comparison voltage generating unit 41N. The voltage differences between the comparison voltages, which the A/D converter is provided through the variable resistance circuits, may be varied.

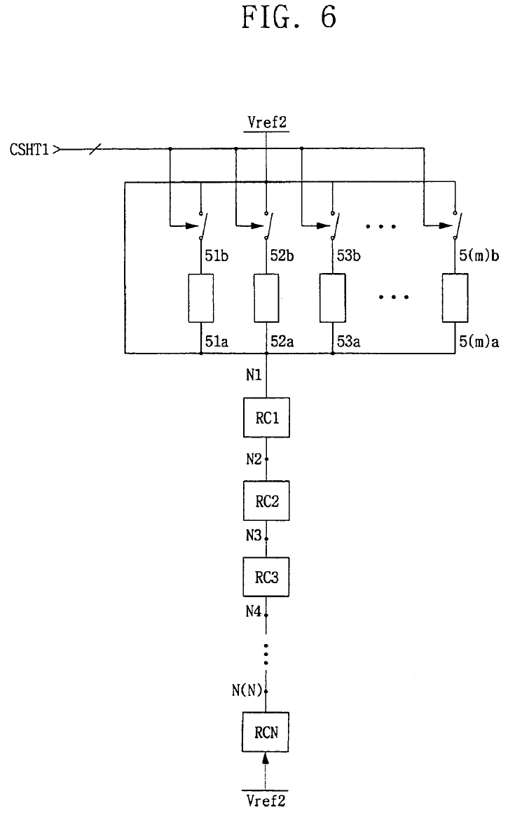

FIG. 6 is a circuit diagram of an A/D converter according to another embodiment of the invention.

The A/D converter of FIG. 6 is configured by replacing the variable resistance circuit 41 of the variable comparison voltage generator 410 of FIG. 5 with m number of resistance circuits 51a to 5(m)a and m number of switches 51b to 5(m)b.

A detailed description will be omitted regarding the circuit of FIG. 6 which has the same configuration and performs the same operation as that of FIG. 5.

The m resistance circuits 51a to 5(m)a are connected to the first reference voltage Vref1 in parallel, and the m switches 51b to 5(m)b are each disposed between each of the m resistance circuits 51a to 5(m)a and the reference voltage Vref1.

The m switches 51b to 5(m)b control connections between the m resistance circuits 51a to 5(m)a and the N comparison voltage generating circuits 411 to 41N in response to m-bit code values of the first shutter control signals CHST1.

If the bit number of the first shutter control signals CHST1 is more than m, the m switches 51b to 5(m)b may be configured to be controlled using m bits of the first shutter control signals CHST1.

Thus, a variable comparison voltage generator 510 controls connections between a particular resistance circuit and the N comparison voltage generating circuits 411 and 41N according to the exposure times of the first shutter control signals CHST1, varies the range of the comparison voltages of the A/D converter, divides the varied range of the comparison voltages into N numbers, and generates and outputs the N comparison voltages, each of which become a reference of each of the N codes provided by the A/D converter.

In this manner, the A/D converter of FIG. 6 sets the range of the plural comparison voltages and selects a range of particular comparison voltages according to the shutter control signal, so that the A/D converter increases its resolution.

In the above-mentioned configuration, the m resistance circuits 51a to 5(m)a and the m switches 51b to 5(m)b are disposed between the first reference voltage Vref1 and the first comparison voltage generating circuit 411, and the voltage differences between the comparison voltages provided by the A/D converter are varied. However, if necessary, the m resistance circuits 51a to 5(m)a and the m switches 51b to 5(m)b may be disposed between the second reference voltage Vref2 and the N^{th} comparison voltage generating circuit 41N, and the voltage differences between the comparison voltages provided by the A/D converter may be varied.

Similarly, the first resistance circuits and switches are disposed between the first reference voltage Vref1 and the first comparison voltage generating circuit 411, and the second resistance circuits and switches are disposed between the second reference voltage Vref2 and the N^{th} comparison voltage generating circuit 41N, and the voltage differences between the comparison voltages provided by the A/D converter may be varied.

The above-mentioned configuration has been described regarding the case where the range of the comparison voltages of the N-bit comparator is varied, but a similar effect may be obtained even in the case where a DC offset of the input signal is varied.

Although a preferred embodiment of the present invention has been described for illustrative purposes, those skilled in the art will appreciate that various modifications, additions and substitutions are possible, without departing from the scope and spirit of the invention as disclosed in the accompanying claims.

As set forth above, the image signal processing system according to the invention is capable of realizing high definition using the low resolution A/D converter, and occupies a small area in the semiconductor integrated circuit and has low power consumption.

Further, the image signal processing system according to the invention can make use of the A/D converter in which a signal-to-noise ratio of the input signal is relatively low.

What is claimed is:

1. An image signal system comprising:
an image sensor for receiving images of a subject in a form of light under the control of a shutter control signal and generating analog signals;
an A/D converter for varying a comparison voltage range according to the shutter control signal and converting the analog signals of the image sensor into digital signals according to the varied comparison voltage range; and
an image data processor for receiving output signals of the A/D converter to obtain movement values and generating the shutter control signal controlling an exposure time of the image sensor.

2. The image signal system as claimed in claim 1, wherein the shutter control signal has a predetermined bit of code value.

3. The image signal system as claimed in claim 2, wherein the A/D converter comprises:
a control signal generator for generating a voltage value of the shutter control signal;
a variable comparison voltage generator for varying the comparison voltage range according to the voltage value and generating and outputting a plurality of comparison voltages corresponding to the varied comparison voltage range; and
a comparator for converting the analog signals into the digital signals using the plurality of comparison voltages of the variable comparison voltage generator.

4. The image signal system as claimed in claim 3, wherein the variable comparison voltage generator comprises:
a comparison voltage range adjustor for continuously varying the comparison voltage range according to the shutter control signal; and
a comparison voltage generator for generating and outputting the plurality of comparison voltages corresponding to the varied comparison voltage range.

5. The image signal system as claimed in claim 4, wherein the comparison voltage range adjustor is a variable resistor.

6. The image signal system as claimed in claim 2, wherein the variable comparison voltage generator comprises:
a comparison voltage range adjustor for setting a range of the plurality of comparison voltages and selecting a particular range of the plurality of comparison voltages according to the shutter control signal; and
a comparison voltage generator for generating and outputting the plurality of comparison voltages corresponding the selected range of the plurality of comparison voltages.

7. The image signal system as claimed in claim 6, wherein the comparison voltage range adjustor comprises:
a predetermined number of switches connected to a power supply on one side thereof and controlled in response to the shutter control signal; and
a predetermined number of resistors connected between the other side 5 of the switches and the comparison voltage generator.
